(19) United States
(12) Patent Application Publication
(10) Pub. No.: US 2017/0268568 A1
(43) Pub. Date: Sep. 21, 2017

(54) Bearing Device

(71) Applicant: Robert Bosch GmbH, Stuttgart (DE)

(72) Inventors: Andreas Riedel, Filderstadt (DE); Michael Mayer, Wiernsheim (DE); Thilo Henke, Leinfelden-Echterdingen (DE); Jan Koalick, Leinfelden-Echterdingen (DE); Lars Schmid, Nuertingen (DE)

(21) Appl. No.: 15/453,253

(22) Filed: Mar. 8, 2017

(30) Foreign Application Priority Data
Mar. 18, 2016 (DE) 10 2016 204 498.2

(51) Int. Cl. F16C 33/10; B23P 15/00

(52) U.S. Cl. CPC F16C 33/1065; B23P 15/003; F16C 2322/50

(57) ABSTRACT

A bearing device includes at least one bearing element. The at least one bearing element has at least one bearing running surface and at least one lubricant pocket. The at least one lubricant pocket is configured to lubricate at least a portion of the bearing running surface of the at least one bearing element. A method of producing the at least one bearing element includes forming the at least one lubricant pocket in the at least one bearing element at least partly by a non-cutting production method.

This application claims priority under 35 U.S.C. §119 to patent application no. DE 10 2016 204 498.2, filed on Mar. 18, 2016 in Germany, the disclosure of which is incorporated herein by reference in its entirety.

### BACKGROUND

The disclosure concerns bearing devices and cylinder running surfaces. Cylinder running surfaces having integrated lubricant pockets made in the cylinder running surfaces by turning or by a honing process have already been proposed.

### SUMMARY

The disclosure is based on a bearing device, in particular for a percussion-mechanism unit of a hand-held power tool, having at least one bearing element, which has at least one bearing running surface, and having at least one lubricant pocket, for lubricating at least a portion of the bearing running surface of the at least one bearing element.

It is proposed that the at least one lubricant pocket be made in the at least one bearing element at least partly by a non-cutting production method. Production of the bearing device can thereby be achieved, advantageously, in a time-saving and inexpensive manner. In addition, a preferably good lubrication and advantageously little wear of the bearing device can be achieved.

The bearing device preferably constitutes at least a part of a percussion-mechanism unit of a hand-held power tool. The bearing element is preferably realized as a functional component of the percussion-mechanism unit, in particular as a hammer tube. It is also conceivable, however, for the bearing element to be realized in a different manner, considered appropriate by persons skilled in the art, such as, for example, as a hammer piston or as a striker. The bearing running surface is preferably realized as a sliding surface. A “lubrication” in this context is to be understood to mean, in particular, formation of a lubricating film to reduce a friction, in particular a sliding friction. Preferably, in comparison with a non-lubricated relative movement between the bearing element and the further bearing element, in which, in particular, the bearing element and the further bearing element are in direct contact with each other, a coefficient of friction can be reduced, in particular, by at least 10%, preferably by at least 25%, preferably by at least 50%, and particularly preferably by at least 75%. The at least one lubricant pocket is preferably constituted by a depression in a surface, in particular in the bearing running surface, of the bearing element, for receiving a lubricant. The non-cutting production method may be realized as electrochemical metal machining and/or as blasting, in particular with removal of a defined proportion of material.

It is additionally proposed that the at least one lubricant pocket be made in the at least one bearing element at least partly by electrochemical metal machining. This makes it possible to achieve a preferably precise and advantageously inexpensive design of the at least one lubricant pocket. Further, the electrochemical metal machining enables the at least one lubricant pocket to be made also in a bearing element that is made, at least partly, of a non-ferrous metal, in particular of aluminum. The at least one lubricant pocket is made in the at least one bearing element at least partly by electrolytic machining. It is also conceivable, however, for the at least one lubricant pocket to be made in the at least one bearing element at least partly by a different electrochemical method, considered appropriate by persons skilled in the art, such as, for example, a PECM (pulsed electrochemical machining) method, or a PEM (precise electrochemical machining) method.

Furthermore, it is proposed that the bearing device comprise at least one further bearing element, which has at least one corresponding bearing running surface, wherein the at least one bearing element and the at least one further bearing element are made at least partly of differing materials. This makes it possible, advantageously, to achieve good bearing properties, and for the bearing device to be adapted in a preferably flexible manner to the respective requirements. The further bearing element is preferably mounted in a movable manner, in particular relative to the bearing element. The expression “mounted in a movable manner” is intended here to define, in particular, a mounting of a unit and/or of an element, the unit and/or the element, in particular dissociated from an elastic deformation of the unit and/or element, having a capability to move along at least one distance, in particular greater than 10 mm, preferably greater than 30 mm, and particularly preferably greater than 50 mm, and/or having a capability to move about at least one axis by an angle, in particular, greater than 15°, preferably greater than 30°, and particularly preferably greater than 45°. The at least one bearing element and the at least one further bearing element are preferably made of a material combination of a non-ferrous metal and iron. The at least one bearing element and the at least one further bearing element are preferably made of a material combination of aluminum and steel. Also conceivable, however, are other material combinations, considered appropriate by persons skilled in the art, such as, for example, aluminum/rubber or steel/rubber. Alternatively, it is also conceivable for the at least one bearing element and the at least one further bearing element to be made at least partly of the same material, for example steel or aluminum.

It is additionally proposed that the bearing device comprise at least one further bearing element, and at least one further lubricant pocket, for lubricating at least a portion of a bearing running surface of the at least one further bearing element, which is made in the at least one further bearing element at least partly by a non-cutting production method. This makes it possible to achieve advantageously time-saving, preferably precise and inexpensive production of the bearing device. In particular, a preferably good and reliable lubrication of the bearing device can be achieved if the at least one further lubricant pocket is made in the at least one further bearing element, in addition to the at least one bearing element that has the at least one lubricant pocket. The non-cutting production method may be realized as electrochemical metal machining and/or as blasting, in particular with removal of a defined proportion of material. The at least one further lubricant pocket is made in the at least one further bearing element at least partly by electrolytic machining. It is also conceivable, for the at least one further lubricant pocket to be made in the at least one further bearing element at least partly by a different electrochemical method, considered appropriate by persons skilled in the art, such as, for example, a PECM (pulsed electrochemical machining) method, or a PEM (precise electrochemical machining) method. The further bearing element is preferably mounted in a movable manner, in particular relative to the bearing element. Preferably, the at least one further lubricant pocket is made in the at least one further bearing element at least partly by electrochemical metal machining.

It is additionally proposed that a ratio of a maximum width of the at least one lubricant pocket to a maximum depth of the at least one lubricant pocket correspond to a value of between 40 and 55. This enables an advantageous result to be achieved in lubrication of the bearing device. The maximum width of the at least one lubricant pocket is preferably constituted by a diameter of the at least one lubricant pocket. Preferably, the at least one lubricant pocket has a U-shaped cross-sectional contour. The U-shaped cross-sectional contour may be of a curved and/or angled design. The at least one lubricant pocket extends, preferably in a U-shape, into a material of the bearing element, as viewed from the bearing running surface of the bearing element. An edge at a transition of the at least one lubricant pocket to the bearing running surface is preferably rounded. It is thereby possible to achieve advantageously little wear of a corresponding bearing element. The at least one lubricant pocket has a maximum width, in particular a diameter, that, in particular, is between 1 mm and 3 mm, preferably between 1.2 mm and 2.5 mm, preferably between 1.4 mm and 2 mm, and particularly preferably between 1.6 mm and 1.8 mm. The at least one lubricant pocket has a maximum depth, as viewed perpendicularly from the bearing running surface of the bearing element, that, in particular, is between 0.02 mm and 0.05 mm, preferably between 0.025 mm and 0.045 mm, preferably between 0.03 mm and 0.04 mm, and particularly preferably between 0.032 mm and 0.038 mm. Particularly advantageously, the at least one lubricant pocket has a maximum depth of 0.035 mm.

Furthermore, it is proposed that the at least one lubricant pocket, as viewed perpendicularly in relation to the bearing running surface, be at least substantially circular. A structurally simple design of the at least one lubricant pocket can thereby be achieved. “At least substantially circular” in this context is to be understood to mean, in particular, that a contour of the at least one lubricant pocket, in particular as viewed along the bearing running surface, corresponds to a circle, in particular at least to 50%, preferably at least to 70%, preferably at least to 90%, and particularly preferably at least to 100% of a total circumference. It is also conceivable for the at least one lubricant pocket to have a different contour, considered appropriate by persons skilled in the art, such as, for example, an oval, rectangular or polygonal contour.

It is additionally proposed that the bearing device have a multiplicity of lubricant pockets, disposed in a distributed manner over at least a portion of the at least one bearing running surface of the at least one bearing element. A preferably uniform lubrication can thereby be achieved. In particular, if the bearing running surface is cylindrical, the lubricant pockets are preferably disposed in a, in particular uniformly, distributed manner over the bearing running surface, all around in the circumferential direction. Alternatively or additionally, a partial distribution of the lubricant pockets, in particular over a sub-region of the bearing running surface, is also conceivable. It is thereby possible to achieve a selective disposition, at points on the bearing running surface that have a greater requirement for lubricant.

Additionally proposed is a hand-held power tool having the at least one bearing device, in particular a hand-held power tool having a percussion-mechanism unit that has the at least one bearing device. It is thereby possible to achieve a preferably inexpensive and durable design of the hand-held power tool. A “hand-held power tool” is to be understood to mean, in particular, a machine for performing work on workpieces, in particular a hammer drill, a chisel hammer, a demolition hammer, or a rotary and/or percussion hammer, and/or another hand-held power tool considered appropriate by persons skilled in the art. The hand-held power tool is preferably realized as a portable hand-held power tool. The hand-held power tool is realized, in particular, as an electric hand-held power tool. The hand-held power tool may be constituted both by a battery-operated hand-held power tool and by a mains-operated hand-held power tool. It is also conceivable, however, for the hand-held power tool to be realized as a hand-held power tool that can be driven, for example, hydraulically, pneumatically or by an internal combustion engine. A “hand-held power tool” is to be understood here to mean, in particular, a power tool, for performing work on workpieces, that can be transported by an operator without the use of a transport machine. In particular, the hand-held power tool has a mass of less than 40 kg, preferably less than 10 kg, and particularly preferably less than 5 kg. Preferably, the hand-held power tool has at least one at least partly vibration-damped handle. Preferably, the hand-held power tool has a quick-change tool receiver, in particular an SDS-max tool receiver or a hex tool receiver. Also conceivable, however, are other designs of the tool receiver that are considered appropriate by persons skilled in the art, such as, for example, as an SDS-plus tool receiver, SDS-quick tool receiver, SDS tool receiver, SDS-top tool receiver, or as a drill chuck for receiving an insert tool having a round shank.

Additionally proposed is a method for producing a bearing device, wherein, in at least one method step, at least one lubricant pocket is made in at least one bearing element of the bearing device at least partly by a non-cutting production method. This makes it possible to achieve advantageously precise and preferably inexpensive production of the at least one lubricant pocket of the bearing device. The non-cutting production method may be realized as electrochemical metal machining and/or as blasting, in particular with removal of a defined proportion of material.

It is additionally proposed that the at least one lubricant pocket be made in the at least one bearing element, in the at least one method step, partly by electrochemical metal machining. It is thereby possible to achieve preferably inexpensive production of the bearing device, with an advantageously good lubrication. Further, the electrochemical metal machining can also be used to make the at least one lubricant pocket in a bearing element that is at least partly made of aluminum. The at least one lubricant pocket is made in the at least one bearing element at least partly by electrolytic machining. It is also conceivable, however, for the at least one lubricant pocket to be made in the at least one bearing element at least partly by a different electrochemical method, considered appropriate by persons skilled in the art, such as, for example, a PECM (pulsed electrochemical machining) method, or a PEM (precise electrochemical machining) method.

It is additionally proposed that the method comprise at least one method step in which at least one further lubricant pocket is made in at least one further bearing element of the bearing device at least partly by a non-cutting production method. The non-cutting production method may be realized as electrochemical metal machining and/or as blasting, in particular with removal of a defined proportion of material. Preferably, the at least one further lubricant pocket is made in the at least one further bearing element at least partly by electrolytic machining. It is also conceivable, however, for the at least one further lubricant pocket to be made in the at least one further bearing element at least partly by a different electrochemical method, considered appropriate by persons skilled in the art, such as, for example, a PECM (pulsed electrochemical machining) method, or a PEM (precise electrochemical machining) method.

The bearing device according to the disclosure, the hand-held power tool according to the disclosure and the method according to the disclosure are not intended in this case to be limited to the application and embodiment described above. In particular, the bearing device according to the disclosure, the hand-held power tool according to the disclosure and the method according to the disclosure may have individual elements, components and units, and method steps, that differ in number from a number stated herein, in order to fulfill a principle of function described herein. Moreover, in the case of the value ranges specified in this disclosure, values lying within the stated limits are also to be deemed as disclosed and applicable in any manner.

### BRIEF DESCRIPTION OF THE DRAWINGS

Further advantages are disclosed by the following description of the drawing. The drawing shows an exemplary embodiment of the disclosure. The drawing, the description and the claims contain numerous features in combination. Persons skilled in the art will also expediently consider the features individually and combine them to create appropriate further combinations.

There are shown in:

FIG. 1 a hand-held power tool having a percussion mechanism and a bearing device, in a schematic side view;

FIG. 2 a detail of the percussion mechanism of the hand-held power tool, and the bearing device, in a schematic side view; and

FIG. 3 a schematic flow diagram of a method for producing the bearing device.

### DETAILED DESCRIPTION

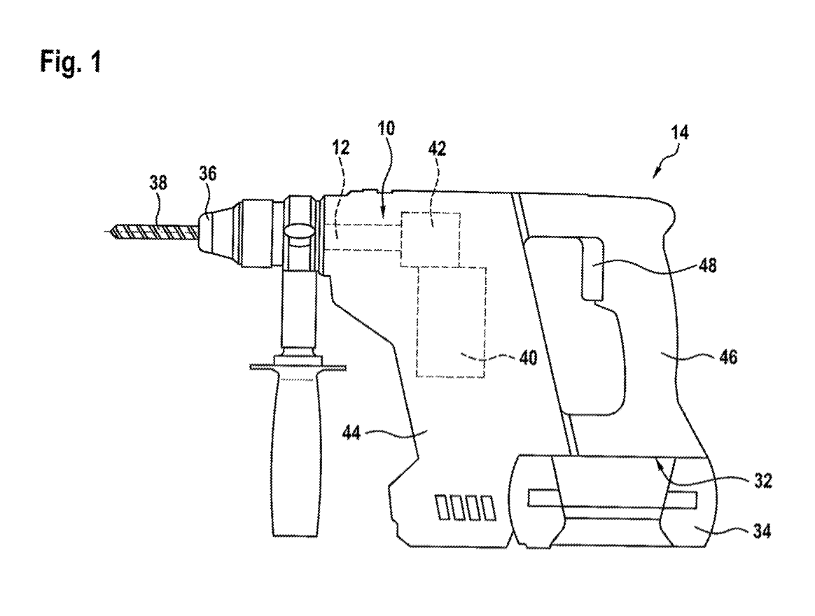

FIG. 1 shows a hand-held power tool 14 having a percussion mechanism unit 12. The hand-held power tool 14 comprises a bearing device 10 for the percussion mechanism unit 12. The hand-held power tool 14 is realized as an electric hand-held power tool. The hand-held power tool 14 is realized as a battery-operated hand-held power tool, and has a battery interface 32, disposed at which there is a hand-held power-tool battery 34. It is also conceivable, however, for the hand-held power tool 14 to be realized as a mains-operated hand-held power tool. The hand-held power tool 14 is constituted by a hammer drill. Also conceivable, however, are other designs of the hand-held power tool 14, considered appropriate by persons skilled in the art, such as, for example, as a percussion power drill, a power drill or a chisel hammer. The hand-held power tool 14 comprises a tool receiver 36. The tool receiver 36 of the hand-held power tool 14 is designed to receive an insert tool 38, which may be realized as a drill bit and/or as a chisel. The tool receiver 36 is constituted by quick-change tool receiver.

Furthermore, the hand-held power tool 14 has a drive unit 40, represented schematically, which comprises an electric motor. The hand-held power tool 14 additionally has a transmission unit 42, represented schematically. The transmission unit 42 in this case has a switchover unit, which is designed for switching over between rotary output, percussive output, and rotary and percussive output. A torque generated by the electric motor of the drive unit 40 is converted by the transmission unit 42 into an operating function that is set by an operator, and is transmitted to the percussion mechanism unit 12. The percussion mechanism unit 12 is directly connected to the tool receiver 36. The drive unit 40, the transmission unit 42 and the percussion mechanism unit 12 are enclosed by a housing 44 of the hand-held power tool 14. A handle 46 adjoins the housing 44, on a side of the hand-held power tool 14 that faces away from the tool receiver 36.

The hand-held power tool 14 has a switch device, not represented in greater detail, which comprises a switching element 48 for activating the electric motor of the drive unit 40. The switching element 48 is realized as a mechanical switching element 48. The switching element 48 is constituted by a pushbutton. Also conceivable, however, are other designs of the switching element 48 considered appropriate by persons skilled in the art, such as, for example, at least partly, as an electronic switching element or as a touch-pad. The switching element 48 is designed to close at least one electrical contact of a switching circuit for the purpose of activating the energy supply to the drive unit 40. The switching element 48 is designed to be actuated directly by an operator. For the purpose of activating the electric motor of the drive unit 40, the operator of the hand-held power tool presses the switching element 48 and thereby puts the hand-held power tool 14 into an active operating mode. To maintain this active operating mode, the operator keeps the switching element 48 pressed down.

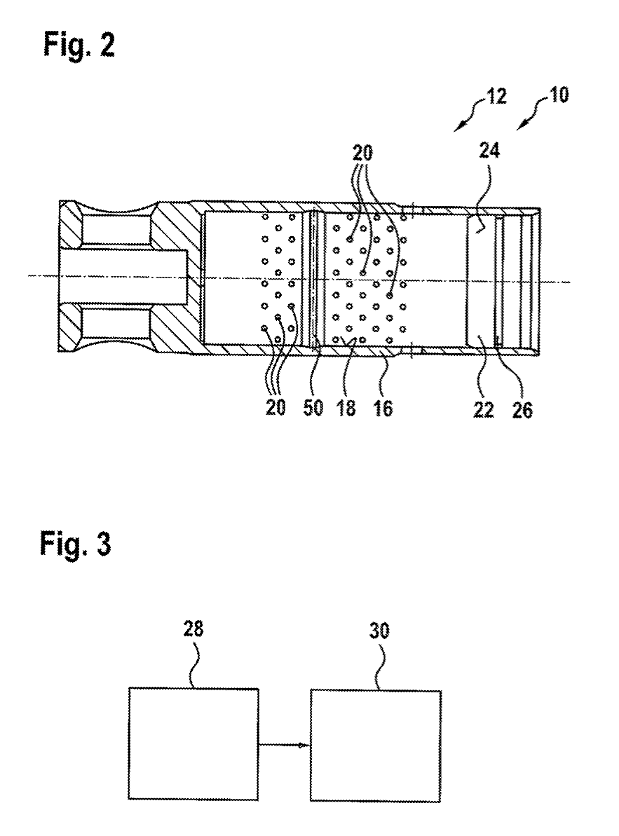

The bearing device 10 is shown in greater detail in FIG. 2. The bearing device 10 has at least one bearing element 16, which has at least one bearing running surface 18. The bearing device 10 has precisely one bearing element 16, which has precisely one bearing running surface 18. The bearing device 10 has at least one movably mounted bearing element 22, which has at least one corresponding bearing running surface 24. The bearing device 10 has precisely one further movably mounted bearing element 22, which has precisely one corresponding bearing running surface 24. Also conceivable, however, is a different number of bearing elements 16, or further bearing elements 22, and/or bearing running surfaces 18, or corresponding bearing running surfaces 24. The bearing element 16 is tubular. The bearing running surface 18 is disposed on an inner side of the tubular bearing element 16. The bearing element 16 is constituted by a hammer tube. The further bearing element 22 is cylindrical. The further bearing element 22 is realized as a hammer piston. The further bearing element 22 is mounted so as to be movable relative to the bearing element 16. The further bearing element 22 is mounted so as to be axially movable in the bearing element 16. In an operating state, the further bearing element 22 executes a linear movement relative to the bearing element 16. The bearing device 10 constitutes a part of the percussion mechanism unit 12.

The bearing device 10 has at least one lubricant pocket 20, for lubricating at least a portion of the bearing running surface 18 of the bearing element 16. The bearing device 10 has a plurality of lubricant pockets 20 for lubricating the bearing running surface 18 of the bearing element 16. The lubricant pockets 20 are designed to receive a lubricant and, when the percussion mechanism unit 12 is in an operating state, to provide a film of lubricant for the bearing running surface 18. The lubricant is constituted by a grease. It is also conceivable, however, for the lubricant to be constituted, for example, by an oil, a soap, a carbon and/or an MoS2. The lubricant pockets 20 are made in the bearing element 16 at least partly by a non-cutting production method. The lubricant pockets 20 are made in the bearing element 16 by a non-cutting production method. The lubricant pockets 20 are made in the bearing element 16 at least partly by electrochemical metal machining. The lubricant pockets 20 are made in the bearing element 16 by an electrochemical material-removing method. The lubricant pockets 20 are made in the bearing element 16 by electrolytic machining. It is also conceivable, however, for the lubricant pockets 20 to be made in the bearing element 16 by a PECM (pulsed electrochemical machining) method, by a PEM (precise electrochemical machining) method, or by blasting, in particular with removal of a defined proportion of material.

The bearing device 10 has a multiplicity of lubricant pockets 20, which are disposed in a distributed manner over at least a portion of the bearing running surface 18 of the bearing element 16. The lubricant pockets 20 are disposed in a distributed manner over the bearing running surface 18 of the bearing element 16. The lubricant pockets 20 are disposed in a uniformly distributed manner over the bearing running surface 18 of the bearing element 16. The lubricant pockets 20, as viewed in the circumferential direction of the bearing element 16, are disposed in a distributed manner over the bearing running surface 18 of the bearing element 16. The lubricant pockets 20 are each disposed at a distance from each other. The lubricant pockets 20, as viewed in the circumferential direction of the bearing element 16, are disposed in rows. As viewed in the axial direction of the bearing element 16, a plurality of successively disposed rows of lubricant pockets 20 are provided. As viewed in the axial direction of the bearing element 16, there is an undercut 50 made in the bearing running surface 18, between two of the rows of lubricant pockets 20.

The lubricant pockets 20, as viewed perpendicularly in relation to the bearing running surface 18, are at least substantially circular. The lubricant pockets 20, as viewed perpendicularly in relation to the bearing running surface 18, are circular. The lubricant pockets 20 each have a maximum width that is between 1.5 mm and 2.0 mm. The lubricant pockets 20 each have a maximum width of 1.6 mm. It is also conceivable, however, for the lubricant pockets 20 each to have a maximum width of 1.8 mm, or a different value, considered appropriate by persons skilled in the art. The maximum width of the lubricant pockets 20 is realized as diameters of the lubricant pockets 20. The lubricant pockets 20 have a maximum depth that is between 0.025 mm and 0.05 mm. The lubricant pockets 20 each have a maximum depth of 0.035 mm. It is also conceivable, however, for the lubricant pockets 20 each to have a different maximum depth, considered appropriate by persons skilled in the art. A ratio of the maximum width of the lubricant pockets 20 to the maximum depth of the lubricant pockets 20 corresponds in each case of a value of between 40 and 55. The ratio of the maximum width to the maximum depth of the lubricant pockets 20 corresponds in each case of a value of 45.7. The lubricant pockets 20 constitute a structure in a sub-region of the bearing running surface 18 that is similar to a surface structure of a golf ball. The lubricant pockets 20 constitute a golf-ball type surface structure of the bearing running surface 18. It is also conceivable, however, for the individual lubricant pocket 20 to be connected to each other, for example via channels.

The bearing element 16 and the corresponding further bearing element 22 are made at least partly of differing materials. The bearing element 16 is made of a metal. The bearing element 16 is made of steel. The further bearing element 22 is made of a metal. The further bearing element 22 is made of aluminum. Also conceivable, however, are any other combinations considered appropriate by persons skilled in the art, such as, for example, steel/rubber. In particular, in the case of a design in which the bearing element 16 is made of steel and the further bearing element 22 is made of rubber, preferably only the bearing element 16 made of steel has lubricant pockets 20.

The bearing device 10 has at least one further lubricant pocket 24, for lubricating at least a portion of a bearing running surface 24 of the further bearing element 22. The bearing device 10 has precisely one further lubricant pocket 26, for lubricating the bearing running surface 24 of the further bearing element 22. It is also conceivable, however, that there are a plurality of further lubricant pockets 26 made in the further bearing element 22. The further lubricant pocket 26, as viewed in the circumferential direction of the further bearing element 22, is realized as a full-perimeter groove. However, other designs of the further lubricant pockets 26, considered appropriate by persons skilled in the art, are also conceivable. The lubricant pocket 26 is designed to receive a lubricant and, when the percussion mechanism unit 12 is in an operating state, to provide a film of lubricant for the bearing running surface 24. The further lubricant pocket 26 is made in the further bearing element 22 at least partly by a non-cutting production method. The further lubricant pocket 26 is made in the further bearing element 22 at least partly by electrochemical metal machining. The further lubricant pocket 26 is made in the further bearing element 22 by an electrochemical material-removing method. The further lubricant pocket 26 is made in the further bearing element 22 by electrolytic machining. It is also conceivable, however, for the further lubricant pocket 26 to be made in the further bearing element 22 by a PECM (pulsed electrochemical machining) method, by a PEM (precise electrochemical machining) method, or by blasting, in particular with removal of a defined proportion of material.

It is also conceivable, however, for at least one lubricant pocket 20, 26, for lubricating the corresponding bearing running surfaces 18, 24, to be made only in the bearing element 16 or in the further bearing element 22.

In addition, a block diagram of a method for producing the bearing device 10 is represented in FIG. 3. The method has at least one method step 28, in which the lubricant pockets 20 are made in the bearing element 16 of the bearing device 10 at least partly by a non-cutting production method. In the method step 28, the lubricant pockets 20 are made in the bearing element 16 of the bearing device 10 by a non-cutting production method. In the method step 28, the lubricant pockets 20 are made in the bearing element 16 of the bearing device 10 by an electrochemical material-removal method, in particular electrochemical metal machining. In the method step 28, the lubricant pockets 20 are made in the bearing element 16 of the bearing device 10 by electrolytic machining. It is also conceivable, however, for the lubricant pockets 20 to be made in the bearing element 16 of the bearing device 10, in the method step 28, by a PECM (pulsed electrochemical machining) method, by a PEM (precise electrochemical machining) method, or by blasting, in particular with removal of a defined proportion of material.

The method has at least one further method step 30, in which the further lubricant pocket 26 is made in the further bearing element 22 of the bearing device 10 at least partly by a non-cutting production method. In the method step 30, the further lubricant pocket 26 is made in the further bearing element 22 of the bearing device 10 by a non-cutting production method. In the method step 30, the further lubricant pocket 26 is made in the further bearing element 22 of the bearing device 10 by an electrochemical material-removing method. In the method step 30, the further lubricant pocket 26 is made in the further bearing element 22 of the bearing device 10 by electrolytic machining. It is also conceivable, however, for the further lubricant pocket 26 to be made in the further bearing element 22 of the bearing device 10, in the method step 30, by a PECM (pulsed electrochemical machining) method, by a PEM (precise electrochemical machining) method, or by blasting, in particular with removal of a defined proportion of material.

The method steps are performed in succession. It is also conceivable, however, for the method steps 28, 30 to be performed at least partly, preferably entirely, simultaneously.

What is claimed is:

1. A bearing device for a percussion-mechanism unit of a hand-held power tool, comprising:
at least one bearing element including:
at least one bearing running surface; and
at least one lubricant pocket configured to lubricate at least a portion of the at least one bearing running surface of the at least one bearing element and formed in the at least one bearing element at least partly by a non-cutting production method.

2. The bearing device according to claim 1, wherein the at least one lubricant pocket is formed in the at least one bearing element at least partly by electrochemical metal machining.

3. The bearing device according to claim 1, further comprising at least one further bearing element including at least one further bearing running surface that corresponds to the at least one bearing running surface of the at least one bearing element, wherein at least a portion of the at least one bearing element comprises a material different from a material of at least a portion of the at least one further bearing element.

4. The bearing device according to claim 3, the at least one further bearing element including further including at least one further lubricant pocket configured to lubricate at least a portion of the at least one further bearing running surface of the at least one further bearing element and formed in the at least one further bearing element at least partly by a non-cutting production method.

5. The bearing device according to claim 1, wherein a ratio of a maximum width of the at least one lubricant pocket to a maximum depth of the at least one lubricant pocket is in a range from 40:1 to 55:1.

6. The bearing device according to claim 1, wherein the at least one lubricant pocket is configured to possess a circular shape as viewed in a direction perpendicular to the at least one bearing running surface.

7. The bearing device according to claim 1, wherein a plurality of lubricant pockets are formed in at least a portion of the at least one bearing running surface of the at least one bearing element in a distributed manner.

8. A hand-held power tool, comprising:
a percussion-mechanism unit including:
a bearing device having:
at least one bearing element with:
at least one bearing running surface; and
at least one lubricant pocket configured to lubricate at least a portion of the at least one bearing running surface of the at least one bearing element and formed in the at least one bearing element at least partly by a non-cutting production method.

9. A method for producing a bearing device, comprising:
forming at least one lubricant pocket in at least one bearing element of a bearing device at least partly by a non-cutting production process, such that at least one lubricant pocket is configured to lubricate at least a portion of a bearing running surface of the at least one bearing element.

10. The method according to claim 9, wherein the non-cutting production process includes electrochemical metal machining.

11. The method according to claim 9, further comprising:
forming at least one further lubricant pocket in at least one further bearing element of the bearing device at least partly by a non-cutting production process, such that at least one further lubricant pocket is configured to lubricate at least a portion of at least one further bearing running surface of the at least one further bearing element that corresponds to the at least one bearing running surface of the at least one bearing element.
